(19) United States
(12) Patent Application Publication
(10) Pub. No.: US 2010/0325327 A1
(43) Pub. Date: Dec. 23, 2010

(54) PROGRAMMABLE ARBITRATION DEVICE AND METHOD THEREFOR

(75) Inventors: Bryan D. Marietta, Austin, TX (US); Jaideep Dastidar, Austin, TX (US); John Vaglica, Austin, TX (US); Mihir A. Pandya, Austin, TX (US)

Correspondence Address: LARSON NEWMAN & ABEL, LLP, 5914 WEST COURTYARD DRIVE, SUITE 200, AUSTIN, TX, 78730, US

(73) Assignee: Freescale Semiconductor, Inc., Austin, TX (US)

(21) Appl. No.: 12/486,387

(22) Filed: Jun. 17, 2009

(51) Int. Cl. G06F 13/36

(52) U.S. Cl. 710/240

(57) ABSTRACT

A system includes a plurality of sources to provide information access requests. An arbiter includes an assignment module to associate a first access request from the first source to one of the plurality of arbitration slots based upon assignment information at a storage location, and a dispatch module to determine one request of a plurality of requests received at the plurality of sources to be dispatched to a resource, memory controller by a dispatch module.

### BACKGROUND

1. Field of the Disclosure

The present disclosure is related generally to data processing devices, and more particularly to data processing devices that process access requests from a plurality of source devices.

2. Description of the Related Art

A data processing device may include multiple data processing subsystems, e.g., sources, that each share access to a single resource. For example, a microprocessor device may include multiple peripherals that each share access to a single memory module. An arbiter can be used to determine which one of a plurality of available access requests from various data processing subsystems to a shared resource is allowed to access the shared resource at a particular time. Furthermore, an access request issued by a data processing subsystem may have an associated priority and corresponding servicing requirements including bandwidth and service latency requirements.

Managing multiple data processing subsystems that have disparate and often conflicting requirements has proven difficult. For example, an arbitration device may sacrifice service latency characteristics to improve bandwidth performance. However, unbounded latency can result in a data processing error known as starvation. Access arbitration can become quite complex as the number of transaction sources becomes large, such as in a highly integrated data processing device. Arbitration algorithms that attempt to balance bandwidth, latency, and starvation prevention services typically attempt to achieve this using multiple overlaid algorithms. Unfortunately, the dynamic interaction of data access traffic and the operation of these complex algorithms can be difficult to accurately predict, and can require a large number of counters, timers, and complex logic to implement. For example, each transaction source can be associated with a starvation timer that when expired indicates that an associated transaction source needs to be serviced in a high priority manner.

### BRIEF DESCRIPTION OF THE DRAWINGS

The present disclosure may be better understood, and its numerous features and advantages made apparent to those skilled in the art by referencing the accompanying drawings.

FIG. 1 is a block diagram illustrating a data processing device including an arbiter module in accordance with a specific embodiment of the present disclosure.

FIG. 2 is a block diagram illustrating a service ring included at the arbiter module of FIG. 1 in accordance with a specific embodiment of the present disclosure.

FIG. 3 is a block diagram illustrating a particular data structure at the storage location used to implement the service ring of FIG. 2 in accordance with a particular embodiment of the present disclosure.

FIG. 4 is a block diagram illustrating a compound service ring included at the arbiter module of FIG. 1 in accordance with a specific embodiment of the present disclosure.

FIG. 5 is a block diagram illustrating a particular data structure at the storage location used to implement the service ring of FIG. 4 in accordance with a particular embodiment of the present disclosure.

FIG. 6 is a block diagram illustrating the arbiter of FIG. 1 in greater detail in accordance with a specific embodiment of the present disclosure.

FIG. 7 is a block diagram illustrating the arbiter of FIG. 1 in greater detail in accordance with another specific embodiment of the present disclosure.

FIG. 8 is a block diagram illustrating a particular data structure at the storage location used to implement the service ring of FIG. 7 in accordance with a particular embodiment of the present disclosure.

FIG. 9 is a block diagram illustrating a service ring associated with the arbiter of FIG. 7 in accordance with a specific embodiment of the present disclosure.

FIG. 10 is a block diagram of the request queues of FIG. 7 in accordance with a specific embodiment of the present disclosure.

FIG. 11 is a block diagram illustrating a plurality of service rings associated with the arbiter of FIG. 7 in accordance with a specific embodiment of the present disclosure.

FIGS. 12-15 are flow diagrams illustrated various methods in accordance with specific embodiments of the present disclosure.

### DETAILED DESCRIPTION

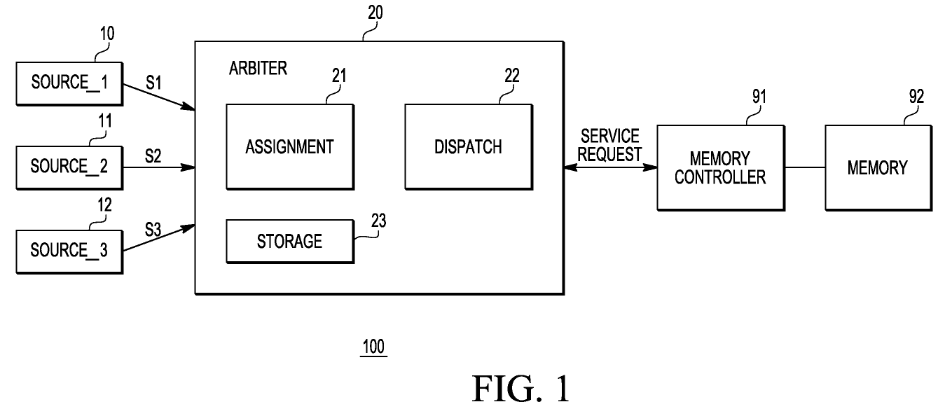

An arbiter module is configured to receive information access requests directed at a shared resource from multiple sources. The arbiter module includes a dispatch module, an assignment module, and a storage location. The dispatch module is configured to receive the information access requests from the multiple sources, and to implement multiple arbitration slots in a defined order to provide a next access request to the shared resource for servicing. The assignment module is configured to associate access requests from a source to one of the arbitration slots based on assignment information stored at the storage location. Various aspects of the present disclosure will be better understood with reference to FIGS. 1-15.

FIG. 1 is a block diagram illustrating a data processing device 100 including an arbiter module in accordance with a specific embodiment of the present disclosure. Data processing device 100 includes a source 10 labeled “SOURCE_1,” a source 11 labeled “SOURCE_2,” a source 12 labeled “SOURCE_3,” an arbiter module 20, a memory controller 91, and a memory 92. Arbiter module 20 includes an assignment module 21, a dispatch module 22, and a storage location 23. Arbiter module 20 has an input to receive access requests from SOURCE_1 via a node labeled “S1,” an input to receive an access request from SOURCE_2 via a node labeled “S2,” an input to receive an access request from SOURCE_3 via a node labeled “S3,” and an output connected to memory controller 91 to provide a memory access request labeled “SERVICE REQUEST.” Memory controller 91 has an output connected to memory module 92.

Sources 10, 11, and 12 represent data processing devices that request information from a common resource, such as memory controller 91, which in turn ensures that accesses to memory module 92 are made serially, though multiple accesses can be pending. For example, each of sources 10, 11, and 12 can independently request access to information stored at memory module 92, e.g., to provide access requests to store and retrieve information at memory module 92. Therefore, sources 10, 11, and 12 can request read access or write access to address locations associated with memory module 92 simultaneously. However, memory controller 91 and memory module 92 can only service one access request at a particular time. Therefore, arbiter module 20 is configured to manage access to memory module 92 in response to an access request from one or more of sources 10, 11, or 12. It will be appreciated that while only those devices connected most directly to arbiter 20 are illustrated at FIG. 1, other source devices can provide access requests to one of sources 10, 11, and 12 for servicing. For example, a SOURCE_4 (not shown) could provide an access request to SOURCE_3, whereby SOURCE_3 would ultimately provide the access request to arbiter 20.

Assignment module 21 is configured to associate access requests received from each of sources 10, 11, and 12 to one or more corresponding arbitration slots of a service ring implemented by arbiter 20, also referred to as an arbitration ring. The access requests are associated to the arbitration slots based on assignment information stored at storage location 23. Dispatch module 22 is configured to implement multiple arbitration slots in a fixed order, such as a round-robin order, to determine which pending access request is to be provided to memory controller 91 for servicing during a particular arbitration slot. In one embodiment, each access request received from a single source can be associated with only one arbitration slot of a service ring based on the assignment information at storage module 23. In another embodiment, each access request received from a single source can be associated with multiple slots of the service ring based on the information at storage module 23. For purposes of discussion herein, unless otherwise indicated, it is assumed that each request from a specific source has the same prioritization characteristics. For example, if a request from a specific source can be prioritized in a manner that affects its arbitration priority, it is assumed that all requests from the same source are at the same priority.

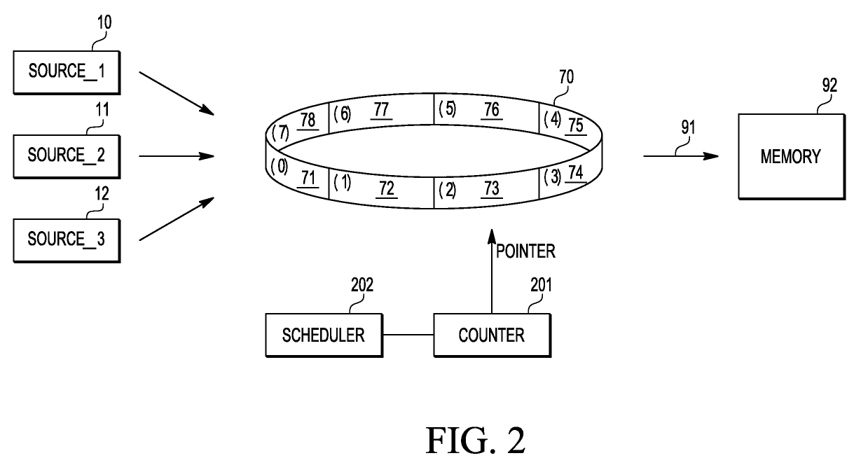

FIG. 2 is a block diagram illustrating a service ring 70 implemented by arbiter module 20 of FIG. 1 in accordance with a specific embodiment of the present disclosure. Service ring 70 includes eight arbitration slots including arbitration slots 71, 72, 73, 74, 75, 76, 77, and 78. Each of arbitration slots 71-78 can be associated with access requests received from SOURCE_1, SOURCE_2, and SOURCE_3. Service ring 70 also includes a counter module 201 and a scheduler module 202. Counter module 201 has an input connected to scheduler module 202, and an output connected to service ring 70 to provide a pointer labeled “POINTER.” Service ring 70 can be implemented in hardware, e.g. registers and control circuitry, or in software, e.g. a data structure.

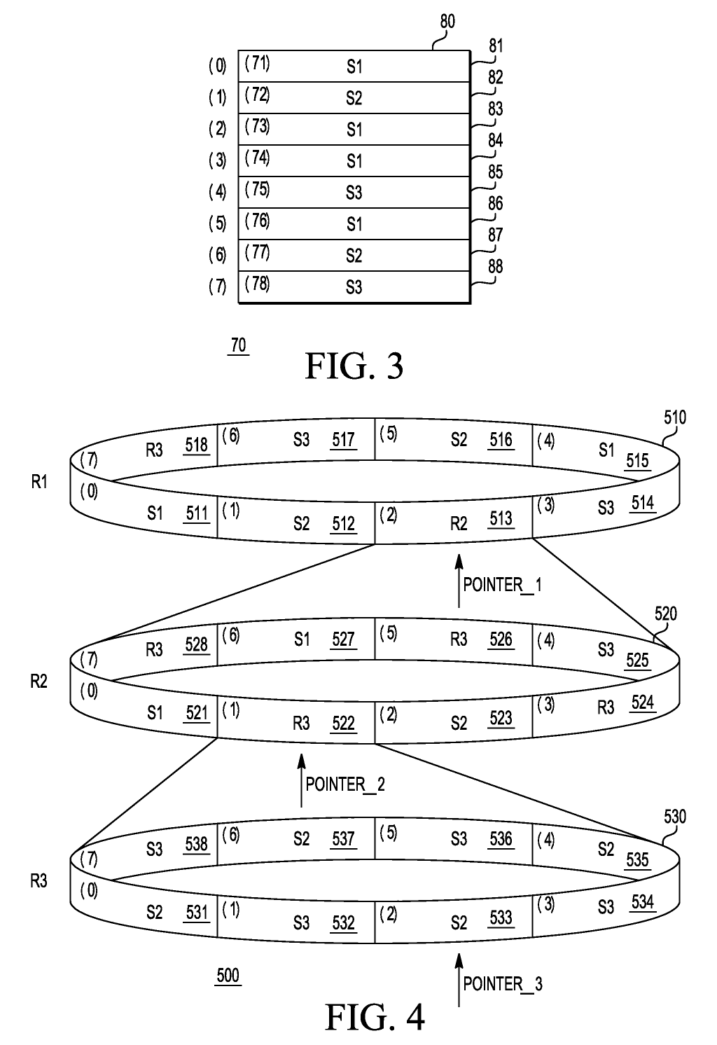

In operation, the arbitration slots 71-78 of the arbitration ring of the arbiter 20 are implemented in an order based upon a policy defined by the scheduler module 202 and implemented by the counter 201. By example, a round-robin order policy is described, though the techniques herein are equally applicable to other ordering policies defined by the scheduler and devices other than counters. The pointer provided by counter 201 identifies which arbitration slot is currently selected, e.g., which arbitration slot is being implemented, and the pointer is configured to advance in a sequential manner from one slot to the next adjacent slot in a modulo manner, e.g., 71, 72, 73, 74, 75, 76, 77, 78, 71, 72, etc. Service ring 70 can include a greater number or a fewer number of arbitration slots. For example, service ring 70 can include four, eight, ten, sixteen, or another number of arbitration slots. Service ring 70 can be implemented using a register stack at storage location 23, wherein each register at the register stack is associated with a unique address corresponding to an arbitration slot of the service ring, and where the value of counter 201 identifies the arbitration slot currently being implemented and is used to select the register of the register stack used to implement a particular arbitration slot of a service ring. For example, each register of the register stack can be associated with a unique address in the range of zero to seven (0-7) as indicated parenthetically next to each register of FIG. 3, and at each of the arbitration slots 71-78 of FIG. 2. For example, counter 201 can include a three-bit counter, which provides a repeating sequence of addresses 0, 1, 2, 3, 4, 5, 6, 7, 0, 1, 2 etc., to sequentially identify the current arbitration slot and select an associated register from the set of registers 80 in a round-robin order, though it will be appreciated that the sequence of values that the POINTER cycles through can be implemented using techniques other than incrementing a counter. For example, shifting techniques and pseudo random techniques can be used.

Advancement of counter 201 is determined by scheduler module 202. Advancement of counter 201 can be based on a number of fixed events, such as the number of access requests serviced at each slot. For example, scheduler module 202 can advance counter 201 from a value of zero (0) to a value of one (1) to select slot 72 after a single access request or after a programmable number of access requests associated with slot 71 have been serviced. Alternatively, counter 201 can be advanced after a programmable amount of time has elapsed servicing access requests associated with slot 71. In the event that there are no pending access requests associated with a current arbitration slot being implemented, e.g., there are no access requests currently available to service during the current arbitration slot, implementation of the arbitration slot can be completed by advancing the pointer immediately to identify the next arbitration slot to be implemented. Alternatively, counter 201 can maintain the value at the POINTER for the allotted time, referred to as the arbitration cycle time, which can be programmed, whereby access requests associated with the current arbitration slot that are received before the allotted time elapses can be immediately serviced by the arbiter. A service ring can include a greater or a fewer number of arbitration slots than that illustrated at FIG. 2.

FIG. 3 is a block diagram illustrating a set of registers 80 stored at storage location 23 that are used by the arbiter 20 to implement the service ring 70 in accordance with a specific embodiment of the present disclosure. The set of registers 80 includes individual registers 81-88 that correspond to arbitration slots 71-78 as indicated parenthetically within registers 81-88. Registers 81-88 are selected by the POINTER value generated by counter 201, as indicated parenthetically adjacent to the registers 81-88, to implement the service ring, wherein each register of register set 80 corresponds to a respective arbitration slot of service ring 70. A specific source, such as SOURCE_1, can be associated with a specific arbitration slot by storing an identifier unique to SOURCE_1 (S1) at a register that corresponds to that specific arbitration slot. For example, register 81 corresponds to arbitration slot 71 as indicated by the value zero (0) parenthetically indicated adjacent to register 81 and at arbitration slot 71 at FIG. 2. Register 81 contains the identifier S1 indicating that the arbitration slot 71 is associated with SOURCE_1, register 82 contains the identifier S2 indicating that the arbitration slot 72 is associated with SOURCE_2, register 83 contains the identifier S1 indicating that the arbitration slot 73 is associated with SOURCE_1, register 84 contains the identifier S1 indicating that the arbitration slot 74 is associated with SOURCE_1, register 85 contains the identifier S3 indicating that the arbitration slot 75 is associated with SOURCE_3, register 86 contains the identifier S1 indicating that the arbitration slot 76 is associated with SOURCE_1, register 87 contains the identifier S2 indicating that the arbitration slot 77 is associated with SOURCE_2, register 88 contains the identifier S3 indicating that the arbitration slot 78 is associated with SOURCE_3.

As mentioned above, counter 201 of FIG. 2 provides a value of zero (0) when arbitration slot 71 is being implemented. As a result, register 81 is selected to provide the indicator stored at register 81, e.g., S1, to the assignment module 21. Register 81 remains selected during arbitration slot 71, thereby allowing access requests associated with SOURCE_1 to be received at the dispatch module 22 for servicing by the arbiter 20. The POINTER is incremented by counter 201 upon completion of the current arbitration cycle to implement arbitration slot 72, thereby selecting register 82, thereby allowing access requests associated with SOURCE_2 to be received at the dispatch module 22 for servicing. Following the service interval for slot 72, the counter is again incremented, thereby allowing access requests to be received from SOURCE_1 during arbitration slot 73. Thus, as the counter is incremented, successive arbitration slots of service ring 70 are implemented using values obtained by selecting the various register entries of register set 80. Assignment information at register set 80 of storage location 23 can be programmed by a user to meet the specific requirements of particular application using data processing device 100. The values stored at register set 80 illustrate how access requests initiated by SOURCE_1 can be serviced more frequently than access requests initiated by SOURCE_2 and SOURCE_3 by associating SOURCE_1 with a larger number of arbitration slots compared to the number of slots associated with SOURCE_2 and SOURCE_3. Thus, access requests initiated by SOURCE_1 have correspondingly reduced service latency.

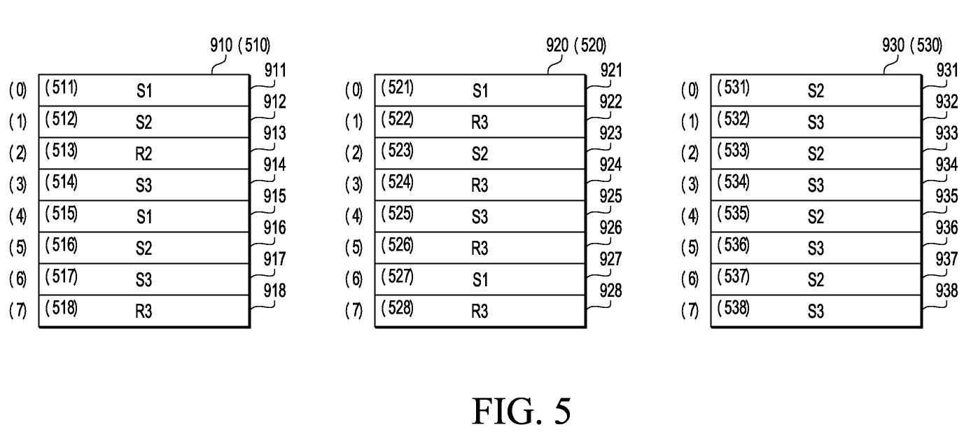

FIG. 4 is a block diagram illustrating a compound service ring 500 included at arbiter module 20 of FIG. 1 in accordance with a specific embodiment of the present disclosure. Compound service ring 500 includes a service ring 510 labeled “R1,” a service ring 520 labeled “R2,” and a service ring 530 labeled “R3.” Service ring 510 includes arbitration slots 511-518 and a pointer labeled “POINTER_1,” service ring 520 includes arbitration slots 521-528 and a pointer labeled “POINTER_2,” and service ring 530 includes arbitration slots 531-538 and a pointer labeled “POINTER_3.” Each arbitration slot of each of service rings 510, 520, and 530 can be associated with any source, and can also be associated with another service ring, based on assignment information at storage location 23. For the purpose of discussion, arbitration slots of compound service ring 500 illustrated at FIG. 4 are configured by the content of the register sets 910, 920 and 930 as indicated at FIG. 5, where: registers 911-918 correspond to arbitration slots 511-518, respectively; registers 921-928 correspond to arbitration slots 521-528, respectively; and registers 931-938 correspond to arbitration slots 531-538, respectively.

In operation, only one arbitration slot of one service ring of compound service ring 500 is active at a particular time, wherein the term “active” with respect to an arbitration slot is intended to mean that access requests associated with that arbitration slot can be serviced. At initialization of arbiter module 20, arbitration slot 511 is implemented as indicated by a value of zero (0) at POINTER_1, since the arbitration slot 511 is associated with SOURCE_1 (see register location 911 of FIG. 5) the arbitration slot 511 is active since pending access requests associated with SOURCE_1 can be serviced. POINTER_1 is advanced in a round-robin order as previously described. If, however, an arbitration slot being implemented is associated with another service ring, such as arbitration slot 513, which is associated with service ring 520, an arbitration slot of the specified service ring is also implemented. Note that while only one arbitration slot of compound service ring 500 can be active during any arbitration cycles, up to one arbitration slot at each service ring of the compound service ring can be implemented during a specific arbitration cycle. For example, arbiter 20 implements arbitration slot 513 when POINTER_1 has a value of 2. However, because arbitration slot 513 is configured to select service ring 520, e.g., associated with service ring 520, the arbiter 20 will also implement the arbitration slot 522 of service ring 520, which is identified by POINTER_2. However, because arbitration slot 522 is configured to select service ring 530, the arbiter 20 will also implement the arbitration slot 533 of service ring 530 identified by POINTER_3. Because arbitration slot 533 is associated with SOURCE_3, the arbitration slot 533 is active to allow service of access requests received from SOURCE_3. Upon completion of the current arbitration cycle, each of POINTER_1, POINTER_2, and POINTER 3 are advanced, and the arbitration slot identified by POINTER_1 is implemented. In this manner, service rings can cause an arbitration slot of another service ring to also be implemented, e.g., pass control to another service ring. In accordance with the specific embodiment illustrated herein, service ring R1 can pass control to either service ring R2 or service ring R3, and service ring R2 can pass control to only service ring R3.

In an embodiment, service ring 510 can be associated with high-priority requests, service ring 520 can be associated with medium-priority requests, and service ring 530 can be associated with low-priority requests. For example, in the event that arbitration slot 511 is active, a pending high-priority access request associated with SOURCE_1 is serviced. If arbitration slot 521 is active, a pending medium-priority access request associated with SOURCE_1 is serviced. If arbitration slot 531 is active, a pending low-priority access request associated with SOURCE_2 is serviced. A compound service ring can include a greater or a fewer number of service rings than that illustrated at FIG. 4, and each included service ring can include a different number of arbitration slots. Arbitration slot 513, 518, 522, and the like, that pass control from a higher service ring to a lower service ring, can be referred to as drop-down slots. A drop-down slot can be used to prevent starvation of low priority access requests by guaranteeing that all access requests are serviced in a deterministic manner. While a drop-down slot in the example described herein is described as limited to passing control from a higher service ring to a lower service ring, it will be appreciated in other embodiments that a drop-down slot could pass control from a lower service ring to a higher service ring.

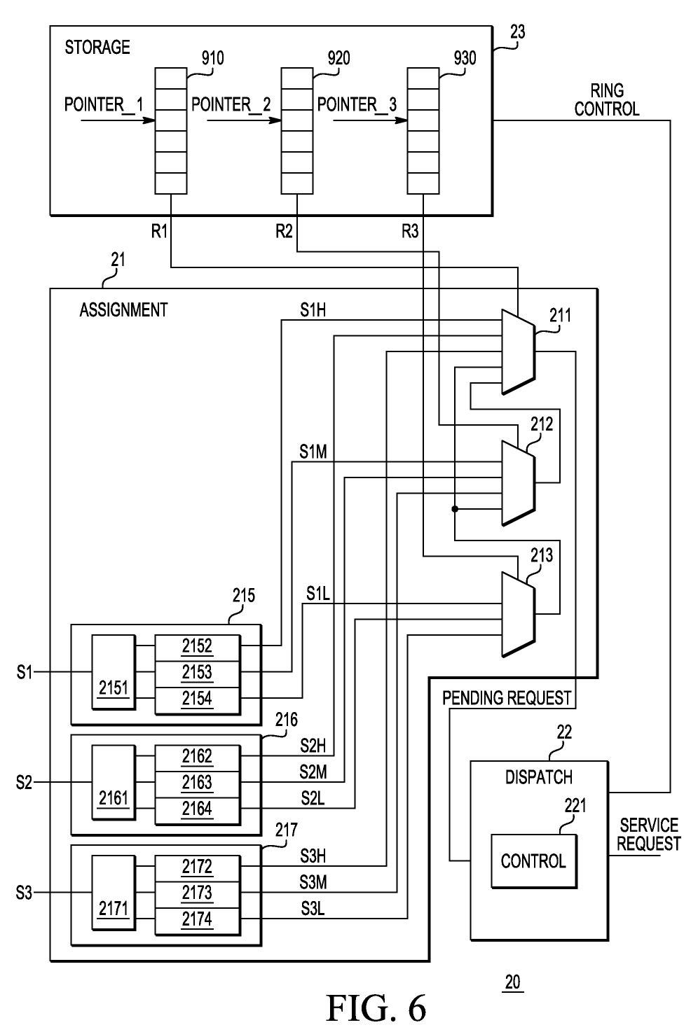

FIG. 6 is a block diagram illustrating arbiter 20 of FIG. 1 in accordance with a specific embodiment of the present disclosure that implements the compound service ring of FIG. 4. Arbiter 20 includes an assignment module 21, a dispatch module 22, and a storage location 23. Assignment module 21 includes a multiplexor 211, a multiplexor 212, a multiplexor 213, a request buffer 215, a request buffer 216, and a request buffer 217. Request buffer 215 includes a queue control module 2151, a high-priority request queue 2152, a medium-priority request queue 2153, and a low-priority request queue 2154. Request buffer 216 includes a queue control module 2161, a high-priority request queue 2162, a medium-priority request queue 2163, and a low-priority request queue 2164. Request buffer 217 includes a queue control module 2171, a high-priority request queue 2172, a medium-priority request queue 2173, and a low-priority request queue 2174. Dispatch module 22 includes a control module 221. Storage location 23 includes the register sets 910, 920, and 930 as described at FIG. 5.

Queue control module 2151 has an input connected to node S1 to receive access requests associated with SOURCE_1 of FIG. 1, an output connected to high-priority request queue 2152, an output connected to medium-priority request queue 2153, and an output connected to a low-priority request queue 2154. High-priority request queue 2152 has an output connected to a node labeled “S1H,” medium-priority request queue 2153 has an output connected to a node labeled “S1M,” and low-priority request queue 2154 has an output connected to a node labeled “S1L.” Queue control module 2161 has an input connected to node S2 to receive access requests associated with SOURCE_2 of FIG. 1, an output connected to high-priority request queue 2162, an output connected to medium-priority request queue 2163, and an output connected to a low-priority request queue 2164. High-priority request queue 2162 has an output connected to a node labeled “S2H,” medium-priority request queue 2163 has an output connected to a node labeled “S2M,” and low-priority request queue 2164 has an output connected to a node labeled “S2L.” Queue control module 2171 has an input connected to node S3 to receive access requests associated with SOURCE_3 of FIG. 1, an output connected to high-priority request queue 2172, an output connected to medium-priority request queue 2173, and an output connected to a low-priority request queue 2174. High-priority request queue 2172 has an output connected to a node labeled “S3H,” medium-priority request queue 2173 has an output connected to a node labeled “S3M,” and low-priority request queue 2174 has an output connected to a node labeled “S3L.”

Request buffer 215 is configured to receive access requests associated with SOURCE_1 and store the access requests in one of three request queues based on a corresponding priority of each respective access request as determined by queue control module 2151. An access request for use of a resource, such as a memory, can include address information, data information if the access request is a write access request, transaction identification information, and any other desired information. In an embodiment, access request priority is determined based on transaction identification information associated with each access request. In another embodiment, access request priority is determined based on a dedicated HIGH/MEDIUM/LOW priority indicator received as part of the access request. Each of high-priority request queue 2152, medium-priority request queue 2153, and low-priority request queue 2154 are configured to store at least one access request. In an embodiment, each request queue is a FIFO register stack capable of storing more than one access request. For example, pending high priority access requests associated with SOURCE_1 can be stored at high-priority request queue 2152 and successively provided at node S1H for eventual servicing. The operation of request buffer 216 and request buffer 217 is similar to the operation of request buffer 215.

Storage location 23 has an output labeled “R1,” an output labeled “R2,” an output labeled “R3,” and an input connected to the dispatch module 22 via a node labeled “RING CONTROL.” Storage location 23 is configured to provide assignment module 21 with assignment information from each of register sets 910, 920, and 930 to associate respective arbitration slots at service rings 510, 520, and 530 with corresponding sources or other service rings. The assignment information is provided to assignment module 21 via signals conducted at nodes R1, R2, and R3. Values of POINTER_1, POINTER_2, and POINTER_3 are maintained in counters at dispatch module 22, and are provided via node RING CONTROL to storage module 23. In an embodiment, service ring 510 is associated with high-priority access requests associated with either SOURCE_1, SOURCE_2, or SOURCE_3; service ring 520 is associated with medium-priority access requests associated with either SOURCE_1, SOURCE_2, or SOURCE_3; and service ring 530 is associated with low-priority access requests associated with either SOURCE_1, SOURCE_2, or SOURCE_3. For example, arbitration slots included at service ring 510 are associated with access requests that are stored at high-priority request queues 2152, 2162, and 2172 of request buffers 215, 216, and 217, respectively. Arbitration slots included at service ring 520 are associated with access requests stored at medium-priority request queues 2153, 2163, and 2173 of request buffers 215, 216, and 217, respectively. Arbitration slots included at service ring 530 are associated with access requests stored at low-priority request queues 2154, 2164, and 2174 of request buffers 215, 216, and 217, respectively.

Each of pointers POINTER_1, POINTER_2, and POINTER_3 identify one arbitration slot at a respective service ring. Storage module 23 provides assignment information to assignment module 21 via nodes R1, R2, and R3. The assignment information identifies an arbitration slot of the plurality of service rings that is currently active based upon which of the inputs of multiplexers 211-213 are selected. Based upon the selected multiplexer inputs, access requests from a source will be provided to the node labeled PENDING REQUEST for dispatch by the dispatch module.

Therefore, assignment module 21 is configured to provide a selected access request associated with SOURCE_1, SOURCE_2, or SOURCE_3 to dispatch module 22 based on assignment information provided by storage location 23. The assignment information is received via nodes R1, R2 and R3 and the assignment information configures each of multiplexors 211, 212, and 213 to route information associated with a selected access request to dispatch module 22. Multiplexor 211 has a select input connected to node R1, an input to receive a high-priority access request from request buffer 215 via node S1H, an input to receive a high-priority access request from request buffer 216 via node S2H, an input to receive a high-priority access request from request buffer 217 via node S3H, an input connected to an output of multiplexor 212, an input connected to an output of multiplexor 213, and an output connected to the node labeled “PENDING REQUEST.” Multiplexor 212 has a select input connected to node R2, an input to receive a medium-priority access request from request buffer 215 via node S1M, an input to receive a medium-priority access request from request buffer 216 via node S2M, an input to receive a medium-priority access request from request buffer 217 via node S3M, and an input connected to the output of multiplexor 213. Multiplexor 213 has a select input connected to node R3, an input to receive a low-priority access request from request buffer 215 via node S1L, an input to receive a low-priority access request from request buffer 216 via node S2L, and an input to receive a low-priority access request from request buffer 217 via node S3L.

Dispatch module 22 is configured to receive access requests from SOURCE_1, SOURCE_2, and SOURCE_3, and to provide a selected access request to a memory controller 80 (FIG. 1) for servicing. Dispatch module 22 has an input connected to node PENDING REQUEST to receive information associated with an access request to be serviced, and an output connected to node RING CONTROL to configure the arbitration ring pointers at storage location 23. Dispatch module 22 also has an output connected to node SERVICE REQUEST to issue a selected access request to memory controller 80 for servicing. Dispatch module 22 includes control module 221, which coordinates successive service requests.

For example, control module 221 is operable to advance each pointer serviced during a current arbitration cycle upon completion of the arbitration cycle. Therefore POINTER_1 is always advanced at the end of the current arbitration cycle to a next arbitration slot. If there is a source associated with the newly identified current arbitration slot, multiplexor 211 is configured to route information associated with any pending access requests from the source to dispatch module 22. In the event that the arbitration slot selected by POINTER_1 is associated with service ring 520, e.g., the arbitration slot is a drop-down slot, the arbitration slot 522 of service ring 520 identified by POINTER_2 is implemented by the selection of the input at multiplexer 211 that is connected to the output of multiplexer 212 based upon the indicator selected by POINTER_2. If there is a pending access request associated with a source associated with arbitration slot 522, multiplexor 212 is configured to route information associated with the pending access request from a selected request queue to dispatch module 22 via multiplexor 211. Otherwise, if arbitration slot 522 is a drop-down slot, as illustrated at FIG. 5, an arbitration slot of service ring 530, identified by POINTER_3, will be evaluated. Control module 221 is configured to advance a service ring pointer following each arbitration request cycle in which an arbitration slot of the service ring is implemented.

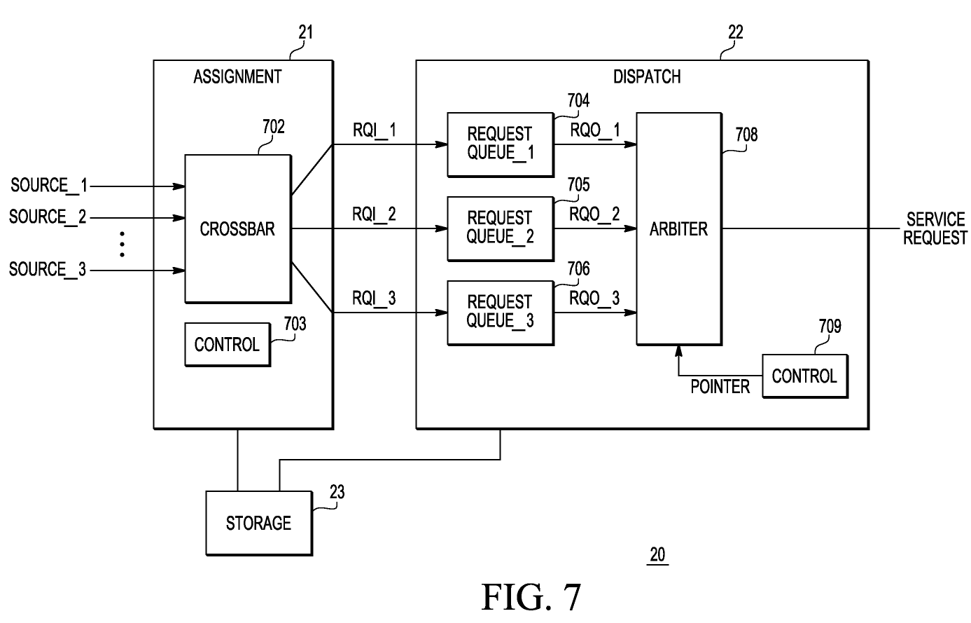

FIG. 7 is a block diagram illustrating an alternate embodiment of arbiter 20 of FIG. 1. Arbiter 20 of FIG. 7 also includes alternate embodiments of assignment module 21, dispatch module 22, and storage location 23. Assignment module 21 includes a crossbar switch 702 and an assignment control module 703. Dispatch module 22 includes an access request queue 704 labeled “REQUEST QUEUE_1,” an access request queue 705 labeled “REQUEST QUEUE_2,” an access request queue 706 labeled “REQUEST QUEUE_3”, an arbiter 708, and a dispatch control module 709. Assignment module 21 and dispatch module 22 have inputs connected to storage location 23. Crossbar switch 702 has inputs connected to receive information from SOURCE_1-SOURCE_8, and an output connected to access request queue 704 via a node labeled “RQI_1,” an output connected to access request queue 705 via a node labeled “RQI_2,” and an output connected to access request queue 706 via a node labeled “RQI_3.” Access request queue 704 has an output connected to arbiter 708 via a node labeled “RQO_1.” Access request queue 705 has an output connected to arbiter 708 via a node labeled “RQO_2.” Access request queue 706 has an output connected to arbiter 708 via a node labeled “RQO_3.” Arbiter 708 has an input connected to dispatch control module 709 via a node labeled “POINTER,” and an output connected to node SERVICE REQUEST.

Crossbar switch 702 is configured to receive access requests from sources SOURCE_1 through SOURCE_8, and associates each respective request with a corresponding one of request queues 704-706 by routing each request upon receipt to one of the request queues based on assignment information stored at location 23. For example, a register set 780 illustrated at FIG. 8 is programmed to associate specific transfer identifiers, which are used to track access requests, to one of request queue 704-706. The assignment information at register set 780 can be used to route access requests received from a source based on transaction identifiers TID0-TID7, whereby access requests with two different identifiers can be routed to the same or different request queue based upon the assignment information. In an embodiment, instead of using assignment information that associates access requests to queues based upon their transaction identifiers, access requests can be associated to a queue based only upon their source, whereby all access requests received from a particular source would be associated with a respective access request queue. For example, all access requests received from SOURCE_1 can be represented by entries at access request queue 704.

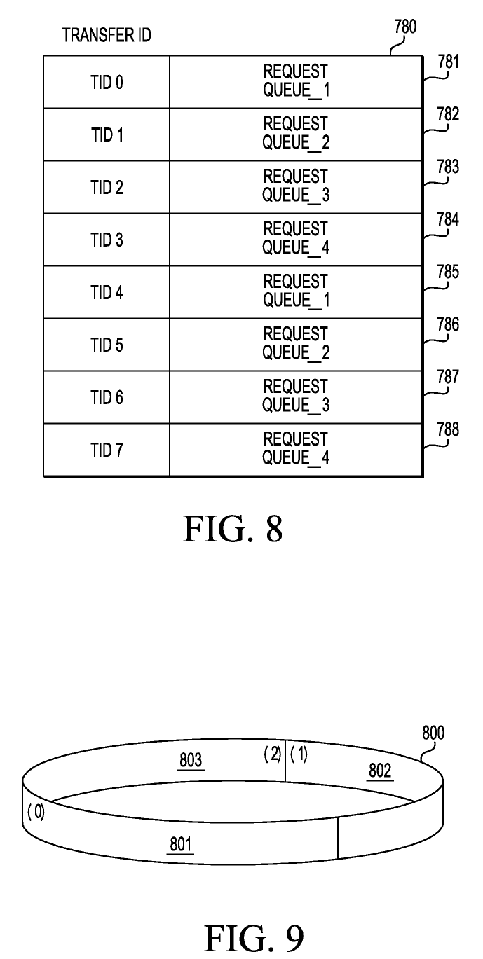

Each of access request queues 704-706 stores access requests received from crossbar switch 702 as they are received, and provides the stored requests to the arbiter 708 one at a time when being serviced by a dedicated arbitration slot implemented by the arbiter 708. Service ring 800, illustrated at FIG. 9, represents a service ring implemented by arbiter 708, and includes three arbitration slots 801-803. Each respective arbitration slot of service ring 800 is dedicated to servicing one of access request queues 704-706. For example, arbitration slot 801 can only service access requests provided from QUEUE_1, arbitration slot 802 can only service access requests provided from QUEUE_2, arbitration slot 803 can only service access requests provided from QUEUE_3. Referring to FIG. 7, control module 709 is configured to provide a pointer via node POINTER that cycles through a series of identifiers based upon a scheduling policy to identify the current arbitration slot, e.g., a round robin policy can be used as illustrated at FIG. 9.

In accordance with a specific embodiment, each of request queues 704-706 can include an arbiter of their own that arbitrates amongst the access requests that it receives. Referring to FIG. 10, a specific implementation 750 of a request queue is illustrated that includes such an arbiter. The specific implementation 750 can be used to implement each of request queues 704-706. The arbiter of FIG. 10 that includes a router module 951, a plurality of queues QS1-QS8, including illustrated queues 952-954 and a request queue arbiter 955. During operation, each received access request is provided to one of queue 952-954 based upon the source of the request. For example, received access requests from SOURCE_1 are routed to queue 952, received access requests from SOURCE_2 are routed to queue 953, etc. The queues 952-954 represent FIFOs, whereby the access requests are provided from queues 952-954 in the same order they where received.

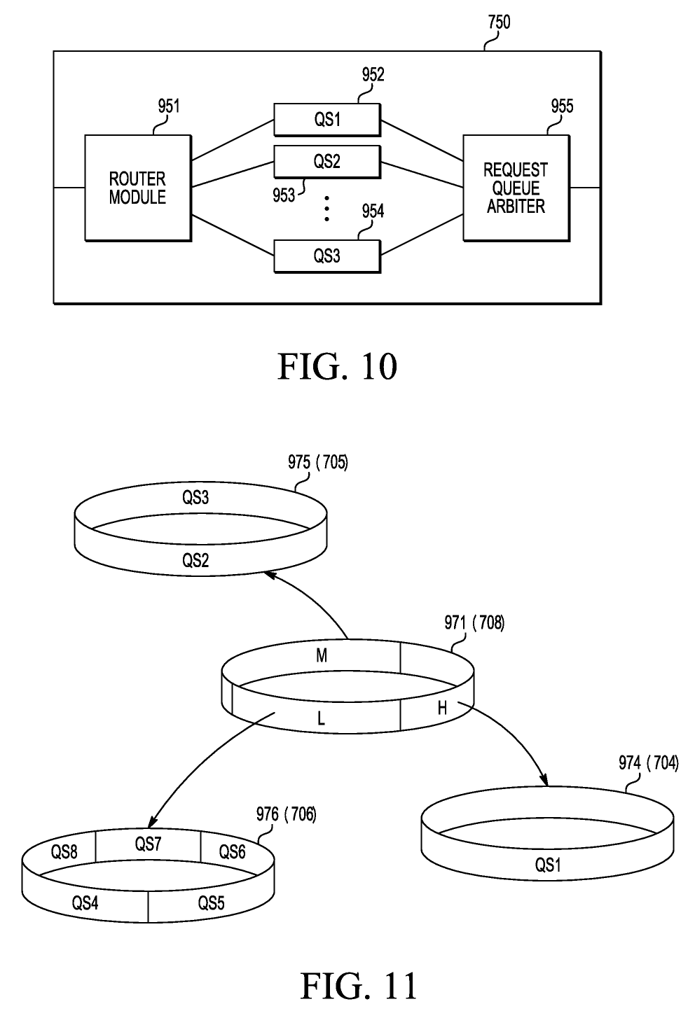

Request queue arbiter 955 can be configured to implement one or more arbitration slots to service its local queues 952-954 based upon the number of queues 952-954 that are configured to store data. For example, request queue 704 can be a high-priority queue that is configured to only receive access requests from SOURCE_1. As such, the request queue arbiter 955 of request queue 704 would be configured to have only one arbitration slot to service queue 952 where the access requests are stored. This is further represented at FIG. 11, which illustrates a main service ring 971, implemented by arbiter 708, that is illustrated to have three arbitration slots labeled “H,” “M,” and “L.” The arbitration slot H of the main service ring 971 is associated a service ring 974 that is implemented by the request queue arbiter 955 of request queue 704. Therefore, when arbitration slot H of service ring 971 is active, a pending request from request queue 704 that is selected by arbiter 955, as indicated by service ring 974, will be serviced. Since there is only one arbitration slot being implemented by the request queue arbiter 955 of request queue 704, e.g., queue QS1, the request queue arbiter 955 will always provide the next access request at queue QS1 as the pending request.

Request queue 705 can be a medium-priority queue that is configured to receive information from SOURCE_2 and SOURCE_3, stored at queues QS2 and QS3 of request queue 705, respectively. As such, the request queue arbiter 955 of request queue 705 is configured to have two arbitration slots to service requests to these queues. This is illustrated at FIG. 11, which illustrates the arbitration slot M of main service ring 971 being associated with a service ring 975, which is implemented by the request queue arbiter 955 of request queue 705, and includes two arbitration slots to service queues QS2 and QS3. Therefore, when arbitration slot M of service ring 971 is active, a pending request from request queue 705 will be selected by arbiter 955 of request queue 705 in the order indicated by service ring 975. Since there are two arbitration slots being implemented, the arbiter will alternately provide access requests from the queues QS2 and QS3 of request queue 705.

Request queue 706 can be a low-priority queue that is configured to receive information from the remaining sources, e.g., SOURCE_4 through SOURCE_8. As such, the request queue arbiter 955 of request queues 706 would be configured to have five arbitration slots to service queues QS4-QS8. This is illustrated at FIG. 11, which illustrates the arbitration slot L of main service ring 971 being associated with a service ring 976 that is implemented by the request queue arbiter 955 of request queue 706, and has arbitration slots associated with queues QS4-QS8. Therefore, when arbitration slot L of service ring 971 is active, a pending request from request queue 706 will be selected by arbiter 955 of request queue 706 from the queues QS4-QS8 in the order indicated by service ring 976. Since there are five arbitration slots being implemented, the arbiter will alternately provide access requests from the queues QS4 through QS8 of request queue 706.

It will be appreciated that the request queue arbiter 952, and the other arbiters described herein, can be programmably configurable. For example, arbiter 952 at each of the request queues can implement a round-robin arbitration policy as described above or a policy that is defined by a user, e.g. a fixed priority. Alternatively, arbiter 952 can implement a FIFO policy, whereby each request received request received at a request queue is serviced by the request arbiter 955 in the order that it was received.

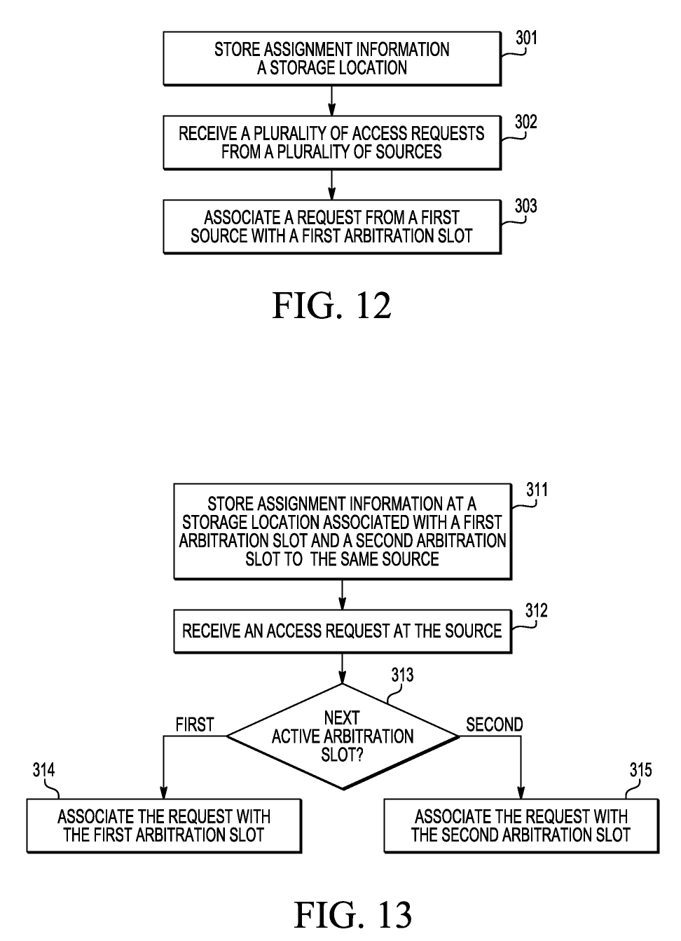

FIG. 12 illustrates a flow diagram in accordance with a specific embodiment of the present disclosure. At block 301, assignment information is stored at a first storage location. The assignment information can be stored at a data structure, such as the registers previously described, that is programmable by a user. In one embodiment, the assignment information can include multiple instances of the same assignment identifier, such as a source indicator, stored at multiple entries of the data structure, where each entry corresponds to different arbitration slot. See FIGS. 3 and 5. In another embodiment, the assignment information can include a single instance of the same identifier, such as a transaction identifier as illustrated at FIG. 8.

At block 302, a plurality of access requests from a plurality of sources are received. For example, a single request can be received from a first source and a single request can be received from a second source. Alternatively, multiple requests can be received from the first and second sources.

At block 303, a request from a first source is associated with a first arbitration slot of a plurality of arbitration slots of an arbitration ring based upon the assignment information.

In one embodiment, the request is associated with the first arbitration slot by virtue of being accessed from a dedicated source location by the arbiter, e.g., a location that is dedicated to receiving requests from a specific source, in response to the first arbitration slot being active and associated with the first source based upon the assignment information, such as previously described at FIGS. 3 and 5. Note that port 215 is considered a dedicated source location since it services only SOURCE_1. In this embodiment, the association of a request to a specific arbitration slot is implemented by an arbitration slot, e.g., by the arbiter, at the time the arbitration slot is active. As a result, the association of an access request to a specific arbitration slot and its dispatch occurs at substantially the same time. Note that this embodiment permits specific access requests to be associated with any one of a plurality of arbitration slots, in that more than one arbitration slot, when active, can service the specific request. However, the arbitration information only allows each arbitration slot to be associated with at most one source.

In an alternate embodiment, the assignment information stored at a location of storage location 23 is indicative of an arbitration queue that is exclusively serviced by a specific arbitration slot implemented by the arbiter, such as previously described at FIGS. 7 and 8. In this embodiment, a routing module, such as a crossbar switch 702, uses the assignment information at an entry of storage location 23, in response to an access request being received from a source, to route a received access request to one of the arbitration queues. Therefore, the routing module associates the first request to a specific arbitration slot by routing and storing the first request at a specifically identified arbitration queue independent as to which arbitration slot being is currently active. E.g., the access request is routed to an appropriate arbitration queue when received, even if the arbitration slot associated with that arbitration queue is not being implemented by the arbiter. For a given set of arbitration information, this embodiment allows any one access request to be associated with only one arbitration slot in that the access request is forwarded to a specific arbitration queue. However, requests from multiple sources can be associated with each arbitration slot of the arbitration ring, because each arbitration slot's dedicated arbitration queue can receive from the routing module access requests from a plurality of sources. Note that assignment information can include transaction identifiers that are used to route access requests, or can include source identifiers whereby all requests from an identified source are routed to a specific arbitration queue. Also note that a significant amount of time can pass between when an access request is associated with an arbitration slot, e.g., when it is routed to its arbitration queue, and when that arbitration slot dispatches the access request.

FIG. 13 illustrates a flow diagram in accordance with a specific embodiment of the present disclosure. At block 311, assignment information is stored at a storage location that includes information that associates a first arbitration slot and a second arbitration slot to the same source. At block 312 an access request is received at the source that is associated with the first and second arbitration slots. At block 313 it is determined whether the first arbitration slot is active prior to the second arbitration slot, in which case flow proceeds to block 314, or if the second arbitration slot is active prior to the first arbitration slot, in which case flow proceeds to block 315.

At block 314, in response to the first arbitration slot being active prior to the second arbitration slot, the request is associated with the first arbitration slot in the manner described with reference to FIG. 6. At block 315, in response to the second arbitration slot being active prior to the first arbitration slot, the request is associated with the second arbitration slot in the manner described with reference to FIG. 6.

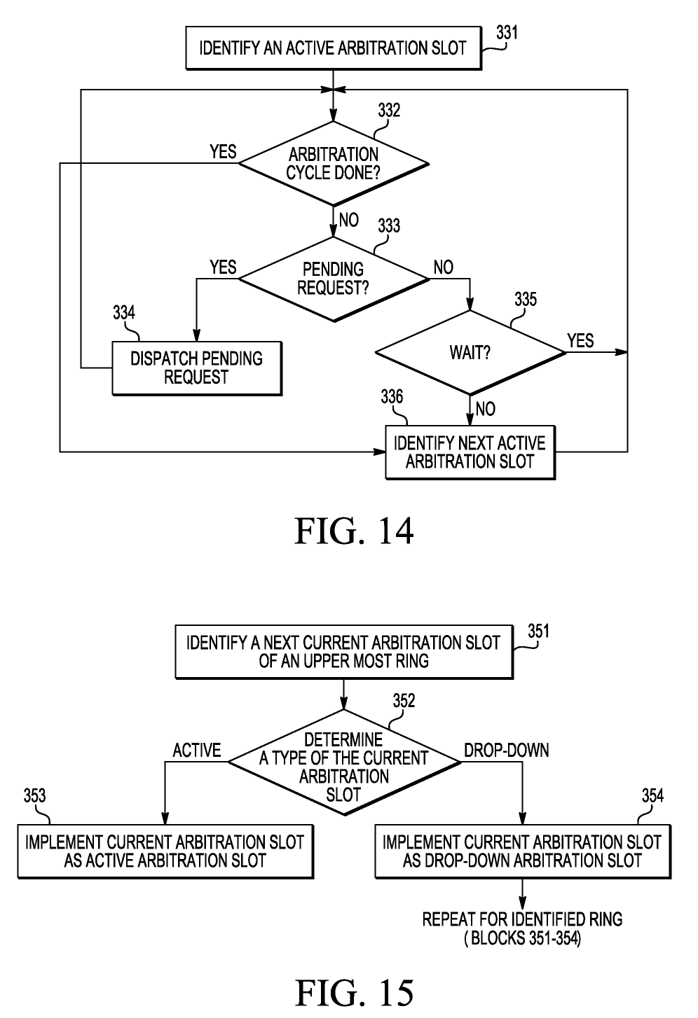

FIG. 14 illustrates a flow diagram in accordance with a specific embodiment of the present disclosure. At block 331, an active arbitration slot is identified and flow proceeds to block 332. At block 332, it is determined if the current arbitration cycle is done, e.g., whether there is more time in the current arbitration cycle. If so, flow proceeds to block 333, otherwise flow proceeds to block 336.

At block 333 implementation of the current arbitration slot begins by determining whether there is a pending access request to be serviced by the current arbitration cycle. If so, flow proceeds to block 334, otherwise flow proceeds to block 335.

At block 334 servicing of a pending access request by the active arbitration slot continues, whereby the access request is dispatched by the arbiter and flow returns to block 332 to determine if the arbitration cycle has ended.

At block 335, there are no pending access requests to be serviced, and it is determined whether to wait at the active arbitration slot for a pending access request by returning to block 332, or to not wait and advance to the next active arbitration slot by proceeding to block 336. In one embodiment, whether to remain at the active arbitration slot or advance to the next active arbitration slot is determined based upon a user programmable indicator.

At block 336, the next active arbitration slot is identified. If flow proceeded to block 336 from block 332, the current arbitration cycle ended normally, e.g., the arbitration cycle timer had expired, and the next arbitration cycle is begun, during which a new active arbitration slot is identified. If flow proceeded to block 336 from block 335, the current arbitration cycle is terminated early, e.g., prior to the current arbitration cycle timer expiring, and the next arbitration cycle is begun, e.g., with the arbitration cycle timer being reset. From block 336 flow returns to block 332.

By example, an arbitration ring can have first and second arbitration slots, wherein the second arbitration slot is next in sequence after a first arbitration slot. Prior to receiving any requests, e.g., no pending requests, it can be determined at block 331 that the first arbitration slot is active and flow proceeds to block 333 via block 332, where it is determined that there are no pending access requests to be serviced. Flow proceeds to block 335 where it is determined that a programmable indicator is asserted to indicate that the first arbitration slot is to remain active until the current arbitration cycle has expired and flow returns to block 332 where it is determined whether the current arbitration is still pending and flow returns to block 333. Assuming no pending requests are received in the interim, this flow will continue until the arbitration cycle expires and the flow proceeds to block 336 where the next active arbitration slot is identified.

By alternate example, flow proceeds to block 336 if at block 335 it is determined that a programmable indicator is negated to indicate that the first arbitration slot is to be completed without waiting for the end of the arbitration cycle. At block 336 a next arbitration slot is identified and is implemented as flow proceeds to block 322.

FIG. 15 illustrates a flow diagram in accordance with a specific embodiment of the present disclosure. At block 351, a next current arbitration slot at an upper-most arbitration ring, such as arbitration ring 510 of FIG. 4, is identified for implementation. At block 352, the type of the current arbitration slot is determined based upon its corresponding assignment information. As described with reference to the register sets of FIG. 5, the current arbitration slot can be a drop-down type arbitration slot, whereby flow proceeds to block 354, or the current arbitration slot can be an active arbitration slot, whereby flow proceeds to block 353.

At block 353, pending access requests, if any, are serviced by the active arbitration slot as described above.

At block 354, a next current arbitration slot at the second ring identified by the drop-down information, such as arbitration ring 520 of FIG. 4, is identified for implementation, whereby the flow described for blocks 351-354 continues in a similar manner for the second ring, and subsequent drop down rings, until an active arbitration ring is determined.

Other embodiments, uses, and advantages of the disclosure will be apparent to those skilled in the art from consideration of the specification and practice of the disclosure disclosed herein. The specification and drawings should be considered exemplary only, and the scope of the disclosure is accordingly intended to be limited only by the following claims and equivalents thereof. For example, while the discussion related to the use of the compound ring 500 of FIG. 5 assumes that only one active arbitration slot is serviced in a lower ring per drop-down event, in other embodiment, more than one active arbitration slot can be implemented per drop-down event. As a further example, when a compound ring is implemented there can be at least one arbitration slot identified as a drop-down slot for each lower ring to prevent starvation.

In a first aspect, a method includes storing assignment information at a storage location, receiving a plurality of requests from a plurality of sources, including a first request from a first source, and associating the first request with a first arbitration slot of a plurality of arbitration slots of a first arbitration ring based upon the assignment information.

In one embodiment of the first aspect, associating the first request includes storing the first request at a first queue of a plurality of queues, based upon the assignment information and independent of the arbitration slot being currently serviced, requests at the first queue are serviceable only during the first arbitration slot. In another embodiment, the method associating the first request includes accessing the first request from a dedicated source location, from a first location identified by the assignment information during the first time slot.

In a further embodiment of the first aspect, the method includes determining whether to associate the first request with the first arbitration slot or a second arbitration slot, wherein determining includes associating the first request with the first arbitration slot in response to the first request being the next available request when the first arbitration slot becomes active prior to a second arbitration slot. Determining also includes associating the first request with a second arbitration slot of the plurality of arbitration slots of the arbitration ring based upon the assignment information in response to the first request being the next available request when the second arbitration slot becomes active prior to the first arbitration slot, wherein the first request is associated with the first and second arbitration slot.

In another embodiment of the first aspect, the assignment information allows an arbitration slot of the arbitration ring to only be associated with requests from a single source. In a further embodiment, each arbitration slot of the arbitration ring can be associated with requests from a plurality of sources. In another embodiment, the plurality of requests further includes a second request from the first source, and further includes associating the second request with a second arbitration slot of the plurality of arbitration slots of the arbitration ring based upon the assignment information.

In a particular embodiment, associating the first access request includes, in response to the first arbitration slot being active, receiving the first request from a port associated with a first source based upon a first portion of the assignment information, and associating the second access request includes, in response to the second arbitration slot being active, receiving the second request based upon a second portion of the assignment information.

In another embodiment of the first aspect, all requests from the first source are associated with the first arbitration slot. In a further embodiment, associating the first request includes receiving the first request from a first queue of a plurality of dedicated source queues based upon the assignment information. In still another embodiment, associating the first request includes accessing the first request, in response to the first time slot being active, based on the assignment information associating the first time slot to the first source.

In a further embodiment of the first aspect, the arbitration ring includes a second arbitration slot that is next in sequence with the first arbitration slot, and further includes determining, prior to receiving the first request, that the first arbitration slot is the next slot to be active and implementing the first arbitration slot, wherein implementing the first arbitration slot includes determining whether a pending request is associated with the first arbitration slot. In response to determining no pending request is associated with the first arbitration slot, waiting a defined amount to determine if a pending request associated with the first arbitration slot is received before servicing the second arbitration slot.

In another embodiment of the first aspect, the arbitration ring includes a second arbitration slot that is next in sequence with the first arbitration slot at the arbitration ring, and further includes determining, prior to receiving the first request, that the first arbitration slot is the next slot to be serviced. The method further includes implementing the first arbitration slot, wherein implementing the first arbitration slot includes determining whether a pending request is associated with the first arbitration slot, and in response to determining no pending request is associated with the first arbitration slot, terminating the current arbitration cycle, and advancing to the next arbitration slot.

In a further embodiment of the first aspect, receiving the plurality of requests includes a second request from the first source; and further includes associating the second request with a first arbitration slot of a plurality of arbitration slots of a second arbitration ring based upon the assignment information. In another embodiment, the method further includes determining that a second arbitration slot is currently being implemented, and in response, determining whether the second arbitration slot is associated with servicing access requests or associated with a second arbitration ring, and implementing a current slot of the second arbitration ring in response to determining the second arbitration slot is associated with the second arbitration ring.

In another particular embodiment, the method includes determining whether the second arbitration slot is associated with dispatching access requests or associated with a second arbitration ring is based upon the assignment information.

In a second aspect, the system includes a plurality of sources to provide information access requests, the plurality of sources including a first source, and an arbiter including a dispatch module and an assignment module. The dispatch module receives the requests from the plurality of sources, and evaluates a plurality of arbitration slots of a first arbitration ring in a round robin order to provide a next access request to a memory controller for servicing. The assignment module associates a first access request from the first source to one of the plurality of arbitration slots based upon assignment information at a storage location, the storage location operable to store the assignment information in response to a write operation.

In one embodiment of the second aspect, the assignment module associates the first access request to one of the plurality of arbitration slots by routing the first access request to a first queue that is dedicated to the one of the plurality of arbitration slots. In another embodiment, the assignment module associates the first access request to one of the plurality of arbitration slots by selecting a first queue that is dedicated to the first source in response to the dispatch module providing the next request. In a further embodiment, in response to the assignment information associating the first time slot of the first arbitration ring to the second arbitration ring, the dispatch module dispatches an access request from a second arbitration ring.

In a third aspect, a method includes identifying a current arbitration slot of a first arbitration ring, determining a type of the current arbitration slot based upon a value stored at a storage location associated with the current arbitration slot, and if the type of the first arbitration slot is a first type, determining if any pending requests are associated with the current arbitration slot, otherwise, if the type of the first arbitration slot is a second type, identifying a current arbitration slot at a second arbitration ring.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A method comprising:
storing assignment information at a storage location;
receiving a plurality of requests from a plurality of sources, including a first request from a first source; and
associating the first request with a first arbitration slot of a plurality of arbitration slots of a first arbitration ring based upon the assignment information.

2. The method of claim 1, wherein associating the first request comprises storing the first request at a first queue of a plurality of queues, based upon the assignment information and independent of the arbitration slot being currently serviced, requests at the first queue are serviceable only during the first arbitration slot.

3. The method of claim 1 wherein associating the first request comprises accessing the first request from a dedicated source location, from a first location identified by the assignment information during the first time slot.

4. The method of claim 1 comprising:
determining whether to associate the first request with the first arbitration slot or a second arbitration slot, wherein determining comprises associating the first request with the first arbitration slot in response to the first request being the next available request when the first arbitration slot becomes active prior to a second arbitration slot, and determining comprises associating the first request with a second arbitration slot of the plurality of arbitration slots of the arbitration ring based upon the assignment information in response to the first request being the next available request when the second arbitration slot becomes active prior to the first arbitration slot, wherein the first request is associated with the first and second arbitration slot.

5. The method of claim 1, wherein the assignment information allows an arbitration slot of the arbitration ring to only be associated with requests from a single source.

6. The method of claim 1, wherein each arbitration slot of the arbitration ring can be associated with requests from a plurality of sources.

7. The method of claim 1 wherein the plurality of requests further comprises a second request from the first source; and further comprising:
associating the second request with a second arbitration slot of the plurality of arbitration slots of the arbitration ring based upon the assignment information.

8. The method of claim 7 wherein:
associating the first access request comprises, in response to the first arbitration slot being active, receiving the first request from a port associated with a first source based upon a first portion of the assignment information, and
associating the second access request comprises, in response to the second arbitration slot being active, receiving the second request based upon a second portion of the assignment information.

9. The method of claim 1 wherein all requests from the first source are associated with the first arbitration slot.

10. The method of claim 1 wherein associating the first request comprises receiving the first request from a first queue of a plurality of dedicated source queues based upon the assignment information.

11. The method of claim 1 wherein associating the first request comprises accessing the first request, in response to the first time slot being active, based on the assignment information associating the first time slot to the first source.

12. The method of claim 1 wherein the arbitration ring includes a second arbitration slot that is next in sequence with the first arbitration slot, and claim 1 further comprising:
determining, prior to receiving the first request, that the first arbitration slot is the next slot to be active; and
implementing the first arbitration slot, wherein implementing the first arbitration slot includes determining whether a pending request is associated with the first arbitration slot, and in response to determining no pending request is associated with the first arbitration slot, waiting a defined amount to determine if a pending request associated with the first arbitration slot is received before servicing the second arbitration slot.

13. The method of claim 1 wherein the arbitration ring includes a second arbitration slot that is next in sequence with the first arbitration slot at the arbitration ring, and claim 1 further comprising:
determining, prior to receiving the first request, that the first arbitration slot is the next slot to be serviced; and
implementing the first arbitration slot, wherein implementing the first arbitration slot includes determining whether a pending request is associated with the first arbitration slot, and in response to determining no pending request is associated with the first arbitration slot, terminating the current arbitration cycle, and advancing to the next arbitration slot.

14. The method of claim 1 wherein receiving the plurality of requests includes a second request from the first source; and claim 1 further comprising
associating the second request with a first arbitration slot of a plurality of arbitration slots of a second arbitration ring based upon the assignment information.

15. The method of claim 1 further comprising:
determining that a second arbitration slot is currently being implemented, and in response, determining whether the second arbitration slot is associated with servicing access requests or associated with a second arbitration ring, and implementing a current slot of the second arbitration ring in response to determining the second arbitration slot is associated with the second arbitration ring.

16. The method of claim 15 wherein determining whether the second arbitration slot is associated with dispatching access requests or associated with a second arbitration ring is based upon the assignment information.

17. A system comprising:
a plurality of sources to provide information access requests, the plurality of sources including a first source;
an arbiter comprising a dispatch module and an assignment module;
the dispatch module to receive the requests from the plurality of sources, and to evaluate a plurality of arbitration slots of a first arbitration ring in a round robin order to provide a next access request to a memory controller for servicing; and
the assignment module to associate a first access request from the first source to one of the plurality of arbitration slots based upon assignment information at a storage location;
the storage location operable to store the assignment information in response to a write operation.

18. The system of claim 17 wherein the assignment module associates the first access request to one of the plurality of arbitration slots by routing the first access request to a first queue that is dedicated to the one of the plurality of arbitration slots.

19. The system of claim 17 wherein the assignment module associates the first access request to one of the plurality of arbitration slots by selecting a first queue that is dedicated to the first source in response to the dispatch module providing the next request.

20. The system of claim 17 wherein in response to the assignment information associating the first time slot of the first arbitration ring to the second arbitration ring, the dispatch module dispatches an access request from a second arbitration ring.

21. A method comprising:
identifying a current arbitration slot of a first arbitration ring;
determining a type of the current arbitration slot based upon a value stored at a storage location associated with the current arbitration slot; and
if the type of the first arbitration slot is a first type, determining if any pending requests are associated with the current arbitration slot, otherwise, if the type of the first arbitration slot is a second type, identifying a current arbitration slot at a second arbitration ring.
